(19) United States
(12) Patent Application Publication
(10) Pub. No.: US 2008/0053135 A1
(43) Pub. Date: Mar. 6, 2008

(54) WATERFALL COOLER

(76) Inventor: Paolo Pietro Petrachi, Gallipoli (IT)

Correspondence Address: PETRACHI PAOLO PIETRO, VIA GIUSTI 2, GALLIPOLI (LE), 73014, omitted

(21) Appl. No.: 11/423,667

(22) Filed: Aug. 29, 2006

(51) Int. Cl. F28D 5/00; B01D 47/00

(52) U.S. Cl. 62/310; 62/304; 261/103

(57) ABSTRACT

The present invention relates to a very simple cooling system that uses the evaporation of water present in a cloth sheet that can lower the temperature of the air that passes through the wet cloth.

The present invention relates to a cooling system, the Waterfall Cooler, in which falling water though a stretched cloth creates a wet barrier that cools the air that passes through the wet cloth.

### BRIEF DESCRIPTION OF THE DRAWINGS

FIG. 1: Detailed drawing of Front View
1.1 Water exit points
1.2 Air front passage
1.3 Air back passage
1.4 Wet cloth chamber
1.5 Water fall direction
1.6 Plastic tube
1.7 Fan
1.8 Water pump
1.9 Water tank
1.10 Back passages are positioned in a way so the air is forced to hit the wet cloth chamber before exiting the front passages.

FIG. 2: Detailed drawing of Side View
2.1 Fan
2.2 Water exit points
2.3 Wet cloth chamber
2.4 Wet cloth chamber
2.5 Air back passages
2.6 Back passages are positioned in a way so the air is forced to hit the wet cloth chamber before exiting the front passages.
2.7 Air front passages
2.8 Water pump
2.9 Water tank

FIG. 3: Drawing of outdoor application

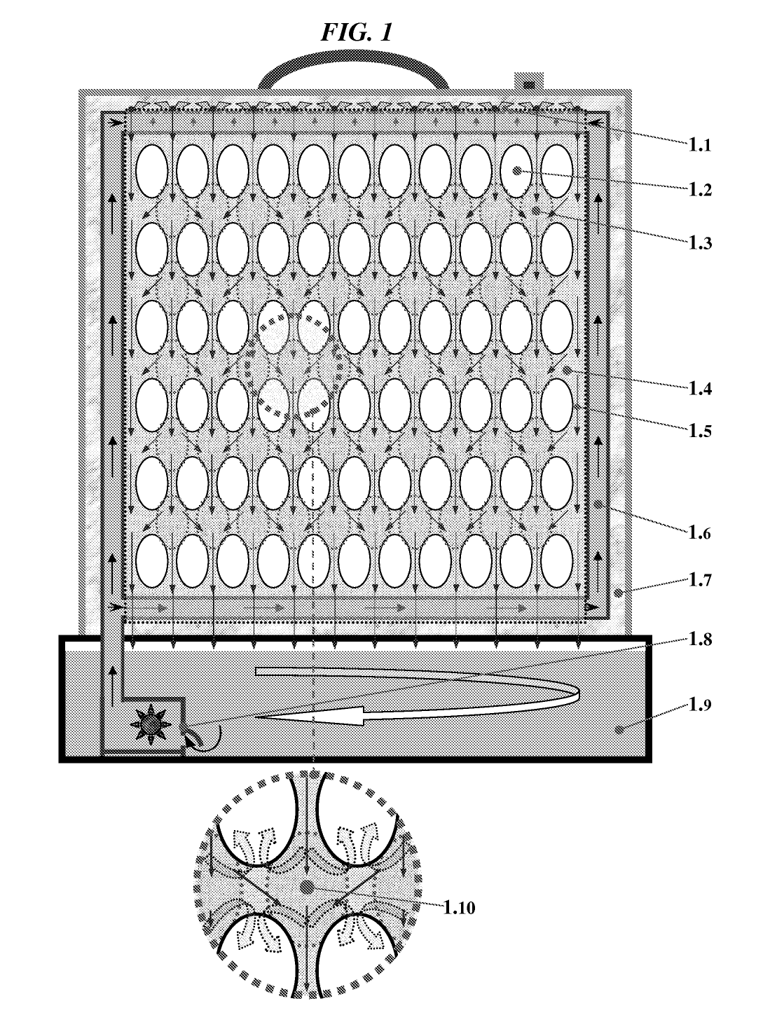

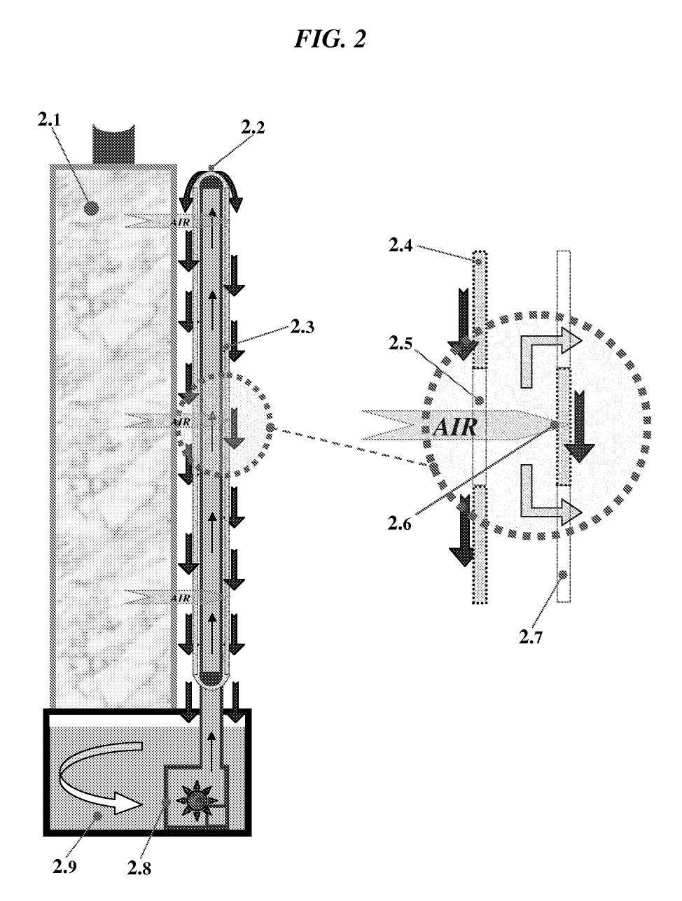

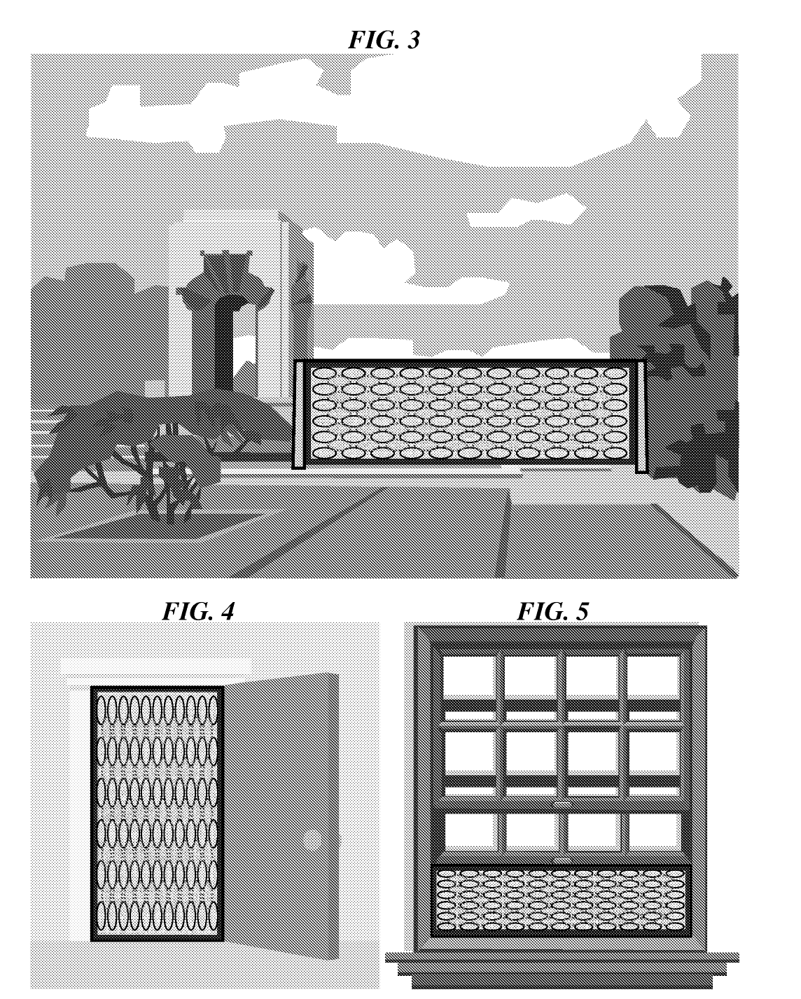

The structure of the Waterfall Cooler for outdoor applications can be made in different shapes and colors so it can blend with the architecture of the surrounding area. The principle is the same as the original waterfall cooler applied on the fan. If placed near a lake or fountain the water can be pulled e dropped in to it without using a separate water tank. To use just the outside air flow, the waterfall cooler should be positioned so the wind from the south (since the winds from the south are the warmest) would hit the back of the chamber. With no wind, a fan could be installed on some of the back air passages of the waterfall cooler to create an artificial Cool Air Breeze.

FIG. 4: Drawing of screen door application

FIG. 5: Drawing of window application

1. A Waterfall Cooler able to drop the temperature of hot and dry air by 10% to 20%.

2. A Waterfall Cooler in which as hot air passes through a wet “Elastic Cloth Chamber” it is cooled by the evaporation of the water and the temperature of the air decreases.

3. A Waterfall Cooler of which the Chamber is made of two (or three) parallel stretched sheets of Elastic Cloth sustained by plastic tubes (in which tubes the water runs through) and when (the chamber) is located in front of the fan, window or a certain open area can create a Cool Breeze compared to air that is before the Chamber.

4. (canceled)

5. (canceled)
